(19) United States
(12) Patent Application Publication
(10) Pub. No.: US 2026/0347715 A1
(43) Pub. Date: Nov. 5, 2026

(54) RECOVERY OF PRODUCTS FROM WATER CONTAINING MULTIPLE SOLID TYPES

(71) Applicant: SunGas Renewables, Inc., Houston, TX (US)

(72) Inventors: Andrew KRAMER, St. Charles, IL (US); Terry HUGHES, Jersey Village, TX (US); Scott SEXTON, Cypress, TX (US); Matthew SPICER, Pearland, TX (US)

(21) Appl. No.: 19/486,629

(22) PCT Filed: May 23, 2024
(86) PCT No.: PCT/US2024/030705

§ 371 Date: Nov. 21, 2025

Related U.S. Application Data
(60) Provisional application No. 63/469,711, filed on May 30, 2023.

(51) Int. Cl. C10J 3/84; B01D 21/02; C02F 1/00; C02F 103/18; C10J 1/213

(52) U.S. Cl. CPC C10J 3/84; B01D 21/10; C02F 1/00; C10J 1/213; C02F 2001/007; C02F 2103/18; C10J 2300/0916; C10J 2300/169

(57) ABSTRACT

Processing configurations are disclosed for recovering portions of solids-containing water (e.g., slag-containing water), having different compositions and quality characteristics, which are useful for different purposes. The solids-containing water generally contains solids of different types (e.g., densities), optionally together with dissolved, water-soluble compounds such as chloride species (e.g., HCl) and nitrogen species (e.g., NH₃). Some or all of the recovered products may have different compositions (e.g., weight percentages) in terms of the different types of solids and/or the water-soluble compounds. The disclosed separations may be practically implemented in, or integrated with, a number of processes that generate solids-containing water, with gasification and its associated syngas cooling operations being exemplary.

### CROSS REFERENCE TO RELATED APPLICATION

This application claims the benefit of priority to U.S. Provisional Application No. 63/469,711, filed May 30, 2023, which is hereby incorporated by reference in its entirety.

### FIELD OF THE INVENTION

Aspects of the invention relate to processes for recovering products from water that contains different types of solids, for example solids having differing densities, such as in the case of slag- and ash-containing water obtained from operations for the cooling of effluents from the gasification of carbonaceous fees (e.g., biomass).

### DESCRIPTION OF RELATED ART

The gasification of coal has been performed industrially for over a century in the production of synthesis gas (syngas) that can be further processed into transportation fuels and other valuable end products. More recent efforts toward developing energy independence with reduced greenhouse gas emissions have led to a strong interest in using biomass as a gasification feed, and thereby an alternative potential source of synthesis gas, as well as its downstream conversion products. Generally, biomass gasification is performed by partial oxidation in the presence of a suitable oxidizing gas containing oxygen and other possible components such as steam. Gasification at elevated temperature and pressure, optionally in the presence of a catalytic material, produces an effluent with hydrogen and oxides of carbon (CO, CO₂), as well as hydrocarbons such as methane. This effluent, which is often referred to as synthesis gas in view of its H₂ and CO content, must be cooled significantly and also treated to remove a number of undesired components that can include particulates, alkali metals, halides, and sulfur compounds, in addition to byproducts of gasification that are generally referred to as tars and oils. Furthermore, downstream conversion of the synthesis gas to value-added products often requires its hydrogen content to be increased, relative to that obtained from gasification alone.

Undesired tar components in the gasifier effluent, which can include fused ring molecules such as naphthalene and pyrene, pose significant challenges in terms of the tendency of such high boiling-temperature molecules to condense from the vapor phase onto lower-temperature surfaces encountered downstream of the gasifier. Physical deposition of tars and oils is known to cause fouling/clogging of process lines, valves, reactors, and other equipment. For these reasons, the thermal destruction of tar is commonly practiced, but this, in turn, requires temperatures of about 1300 °C, well exceeding those of the gasifier and sufficient to cause melting and/or slagging of ash that is also present in tar-laden syngas stream or gasifier effluent. The molten material or slag is itself a source of potential fouling and plugging, due to deposition at cooler downstream temperatures, such as encountered in equipment for upgrading of synthesis gas to end products. To mitigate these problems, the use of cooling operations whereby the slag-containing syngas is contacted directly with water has been found beneficial for the removal of unwanted solids from the flowing gas stream. For example, a sufficiently large-sized radiant syngas cooler (RSC) is viewed as being effective for separating slag via a quench chamber at the bottom of this apparatus. The present state of the art would benefit from improvements in the ability to further classify solid and water-soluble contaminants residing in industrial water products generally, and more particularly those derived from gasification and containing various byproducts resulting from the exposure of biomass and other carbonaceous feeds to high-temperature processing conditions.

### SUMMARY OF THE INVENTION

Aspects of the invention are associated with the discovery of gasification processes utilizing carbonaceous feeds and preferably biomass, which can implement one or more strategies for recovering portions of slag-containing water, having different compositions and quality characteristics, which are useful for different purposes. Other aspects more generally relate to the separation of water that contains solids of different types (e.g., densities), optionally together with dissolved, water-soluble compounds such as chloride species (e.g., HCl) and nitrogen species (e.g., NH₃). With respect to either these specific or more general aspects, some or all of the recovered products may advantageously have different compositions (e.g., weight percentages) in terms of the different types of solids and/or the water-soluble compounds. Representative gasification processes and separations according to the invention can therefore add one or more degrees of resolution and corresponding products (e.g., according to one or more separation stages performed), for example compared to the removal of relatively heavy solids but without separation of relatively light solids and/or without management of water-soluble compounds.

Further aspects relate to, in the separation of water that contains solids and water-soluble compounds, the collection, transport, and removal of various fractions of these solids and compounds, in a water-containing carrier. The differing fractions may have respective, differing contents of one or more of slag, ash, non-combustible solids, and/or post-combustion solids, optionally in addition to differing contents of water-soluble compounds, with the different types of solids and optionally the water-soluble compounds concentrating in certain locations from which they are withdrawn (e.g., in the bottom of a vessel that is a reservoir for slag-containing water of a radiant syngas cooler). According to particular embodiments, these fractions may be enriched in, and/or may comprise substantially all of an initial amount of (e.g., the amount initially present in the slag-containing water), one or more of these different types of solids and/or one or more water-soluble compounds. Specific aspects relate to addressing the problem of collection, transport, and removal of lighter (lower specific gravity) and heavier (higher specific gravity) solids from a syngas process stream, or gasifier effluent. This problem is encountered as a practical matter, for example, in the case of a radiant syngas cooler or other cooler that separates these solids by generating a slag-containing water, in the process of cooling the syngas. Advantageously, it has been discovered that effective separations of products from this slag-containing water, having different compositions, values, and/or uses, can be achieved through placement of separation equipment according to configurations and flow schemes described herein, allowing for the resolution of solids of differing densities in products that are separated from the slag-containing water. Separation performance and/or water conservation can be increased by utilizing continuous or intermittent recycle of certain fractions. Representative water-containing products, for example respective products being enriched in lighter solids and being enriched heavier solids, may be in the form of slurries, suspensions, or floating solids. Additional products may include solutions being enriched in one or more water-soluble compounds.

Other important benefits of gasification processes and, more generally, separations, described herein relate to the ability to achieve the simultaneous removal of products enriched in lighter (e.g., floating) solids, heavier (e.g., sinking) solids, and water-soluble compounds, from solid-containing industrial water. A specific example of such water is encountered in a syngas cooler sump or slag water system. Further advantages reside, according to particular embodiments, in separating solids-containing water 100 (e.g., obtained from the sump of an RSC or CSC), using two separate vessels. This allows separate methods to be selected for, or tailored to, concentrating solids of different types, such as concentrating lower-density (light) solids in a product of a first vessel, using a first method (e.g., hydrocyclone separation), and/or concentrating higher-density (heavy) solids in a product of a second vessel, using a second method (e.g., gravity settling).

Particular embodiments of the invention are directed to processes for recovering products from slag-containing water within a vessel. Representative products are those in the form of solid-water slurries and suspensions, as well as other forms of solid-water combinations. The processes comprise (a) withdrawing, from respective upper and lower positions of the vessel (e.g., vertical heights of a liquid level within the vessel, such as a first stage separation vessel) an upper slag water portion and a lower slag water portion, which refers namely to portions of the slag-containing water. The processes may further comprise (b)(1) separating the upper slag water portion (further) into a dirty water portion and a suspended solids-containing water portion, withdrawn from respective upper and lower positions of (e.g., vertical heights of a liquid level of the upper slag water portion within) a second stage upper separation vessel; and/or (b)(2) separating the lower slag water portion (further) into a lean slag water portion and a rich slag water portion, withdrawn from respective upper and lower positions of (e.g., vertical heights of a liquid level within) a second stage lower separation vessel. The processes may further comprise (c) recovering all or part, such as at least a first part, of the dirty water portion as a dirty water product; and/or (d) recovering at least part of the suspended solids-containing water portion in a solids-containing water product.

Other particular embodiments of the invention are directed to processes for gasification of a carbonaceous feed. The processes comprise, in a gasifier, contacting the carbonaceous feed with an oxygen-containing gasifier feed, under gasification conditions, to provide a gasifier effluent comprising H₂, CO, and solids comprising slag and fly ash. The processes may further comprise, in a cooling operation or a quenching operation (e.g., in a vessel of such cooling or quenching operation), contacting all or part of the gasifier effluent, optionally following one or more intervening operations, with makeup water to obtain (i) a slag-containing water and (ii) a cooled gasifier effluent or a quenched gasifier effluent. The processes may further comprise separating the slag-containing water to recover at least a dirty water product and a solids-containing water product having respective, lower and higher solids contents. That is, the separation results in different products with different compositions.

These and other embodiments, aspects, and advantages relating to the present invention are apparent from the following Detailed Description.

### BRIEF DESCRIPTION OF THE DRAWINGS

A more complete understanding of the exemplary embodiments of the present invention and the advantages thereof may be acquired by referring to the following description in consideration of the accompanying figures.

FIG. 1 depicts a flowscheme illustrating an embodiment of a process for the separation and recovery of products from solids-containing (e.g., slag-containing) water, which process employs a number of possible features as described herein.

FIG. 2 depicts flowscheme illustrating an embodiment of a process (e.g., a gasification process) for converting a carbonaceous feed to syngas, which process may generate solids-containing water and may therefore be utilized in conjunction, or integrated, with a process as illustrated in FIG. 1.

For the sake of simplicity, multiple features are illustrated and described in each of the figures, with the understanding that not all features (e.g., not all individual operations, such as separations and other operations, and their associated process streams and equipment) are required and that various specific features can be implemented independently of others.

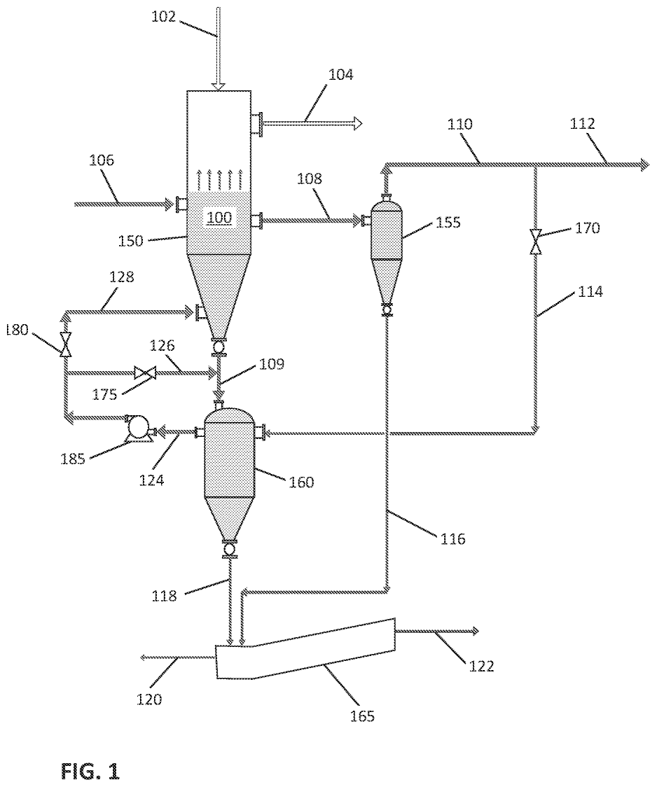

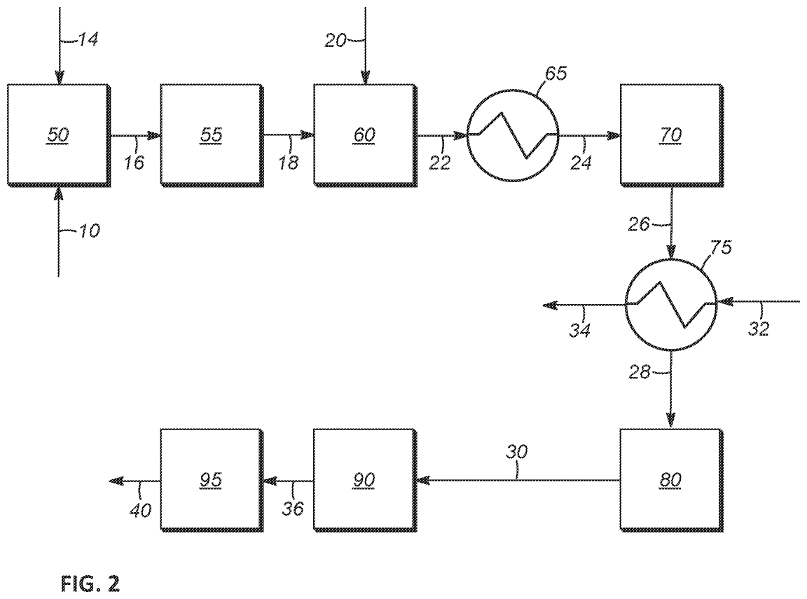

In order to facilitate explanation and understanding, FIGS. 1 and 2 provide an overview of these and other features for implementation in separation processes and/or in gasification processes. Some associated equipment such as certain vessels, heat exchangers, valves, instrumentation, and utilities, are not shown, as their specific description is not essential to the implementation or understanding of the various aspects of the invention. Such equipment would be readily apparent to those skilled in the art, having knowledge of the present disclosure. Other processes for separating solids-containing water, such as obtained in the production of syngas and/or its conversion products such as renewable liquids, according to other embodiments within the scope of the invention and having configurations and constituents determined, in part, according to particular processing objectives, would likewise be apparent.

### DETAILED DESCRIPTION

The expressions “wt-%” and “mol-%,” are used herein to designate weight percentages and molar percentages, respectively. The expressions “wt-ppm” and “mol-ppm” designate weight and molar parts per million, respectively. For ideal gases, “mol-%” and “mol-ppm” are equal to percentages by volume and parts per million by volume, respectively. The terms “barg” and “psig” are used herein to designate gauge pressures (i.e., pressure in excess of atmospheric pressure) in units of bars and pounds per square inch, respectively, whereas the terms “bar” and “psi” are used herein to designate absolute pressures. For example, gauge pressures of 0 barg and 0 psig are approximately equivalent to absolute pressures of 1 bar and 14.5 psi, respectively.

Unless otherwise stated, the solids content of various fractions and products described herein refers to weight percentage (wt-%).

The term “substantially,” as used herein, refers to an extent of at least 95%. For example, the phrase “substantially all” may be replaced by “at least 95%.” The phrase “substantially the same as” may be replaced by “within +/−5% of.” The phrases “all or part,” “at least a first part,” and “at least a second part,” are meant to encompass, in certain embodiments, “at least 50%,” “at least 75%,” “at least 90%,” or “all” of the total to which they refer. Likewise, designated portions, such as a “dirty water portion” or “lower slag water portion” may represent these percentages (but not all) of the total, and particularly these percentages (but not all) of the total to which they refer, such as the total from which they are separated.

Reference to any starting material, intermediate product, or final product, which are all preferably process streams in the case of continuous processes, should be understood to mean “all or a part” of such starting material, intermediate product, or final product, in view of the possibility that some portions may not be used, such as due to sampling, purging, diversion for other purposes, mechanical losses, etc. Therefore, for example, the phrase “combining the rich slag water portion and the suspended solids-containing water portion” should be understood to mean “combining all or a part of the rich slag water portion and all or a part of the suspended solids-containing water portion.” As in the case of “all or part” being expressly stated, when “all or a part” is the understood meaning, this phrase is should further be understood to encompasses certain and preferred embodiments as noted above.

Certain aspects of the invention relate to recovery of products having different compositions from solids-containing water, and especially water that comprises solids of differing densities. A particular example of commercial relevance is slag-containing water that, in addition to slag, also comprises less dense solids referred to as “fly slag” or “fly ash,” which may be suspended in water and/or which may float on the surface of water. According to particular embodiments described herein, such slag-containing water may be obtained (e.g., as a byproduct) from the gasification of a carbonaceous feed (e.g., biomass), with representative processes comprising: (i) in a gasifier, contacting the carbonaceous feed with an oxygen-containing gasifier feed, under gasification conditions, to provide a gasifier effluent comprising H₂, CO, and solids comprising slag and fly ash, and (ii) in a cooling operation or a quenching operation (or vessel of such operation), contacting all or part of the gasifier effluent, optionally following one or more intervening operations, with makeup water to obtain (i) a slag-containing water and (ii) a cooled gasifier effluent or a quenched gasifier effluent. The slag-containing water may then be separated to recover at least a dirty water product and a solids-containing water product having respective, lower and higher solids contents, meaning that these products have different compositions. A representative intervening operation is a tar removal operation as described herein, and therefore solids such as slag and fly slag in the slag-containing water may be produced from of exposure of the carbonaceous feed (e.g., biomass) to a combination of not only the high temperatures used for gasification, but also the even higher temperatures used for tar removal.

Whereas gasification is an exemplary syngas-producing operation that can generate slag-containing water, separations described herein are likewise applicable to, and may be integrated with, other operations for transforming carbonaceous feeds. These include operations that similarly employ oxidative conditions and therefore include the contacting of a carbonaceous feed with an oxygen-containing feed or, more broadly, an oxidant-containing feed (e.g., utilizing H₂O, CO₂, and/or CO as an oxidant). Specific operations are partial oxidation (Pox) and autothermal reforming (ATR) for the conversion of carbonaceous feeds, which can likewise generate syngas that contains entrained solids, with this syngas being subjected to downstream cooling via contacting with water. A resulting solids-containing water (e.g., slag-containing water) may be separated according to processes described herein. Regardless of which base transformation (e.g., gasification, Pox, or ATR) is utilized to obtain solids-containing syngas that is contacted with makeup water in a cooling operation, this makeup water is generally substantially free of solids initially, such as in the case of boiler feed water being used.

Separations according to embodiments of the invention may therefore advantageously resolve solids having different densities (e.g., higher density slag and lower density fly slag), preferentially in different products that also contain water. The starting material, from which the solid-containing products may be recovered, may be slag-containing water obtained from contacting syngas (e.g., a gasifier effluent, Pox effluent, or ATR effluent) with makeup water. The slag-containing water, or solids-containing water more generally, may have a solids content from about 0.3 wt-% to about 15 wt-%, such as from about 0.5 wt-% to about 10 wt-% or from about 1 wt-% to about 5 wt-%. With respect to the total solids present being within these ranges, this can include the combined contents of floating/suspended solids (e.g., slag ash), heavier solids (e.g., slag), and optionally any other solids present. Particular separations may utilize at least two separation stages, according to which one or more portions (e.g., an upper slag water portion and/or a lower slag water portion) initially separated in a first stage separation (e.g., separated from a vessel used for syngas cooling) are subjected to at least a second separation stage. The separation stages may, in general, involve gravity separations utilizing separation vessels having suitable volume/residence time characteristics, for sufficient settling of the particular liquid-solid systems contained in these vessels, as needed to resolve distinct portions (e.g., water portions that are enriched in either high density solids such as slag or low density solids such as fly slag).

In this regard, aspects of the invention exploit the fact that solid particles of varying density, and which may in some cases exhibit a substantially bi-modal or multi-modal density distribution, are typically produced in the conversion of carbonaceous feeds to syngas (e.g., via gasification, Pox, or ATR). This allows for water, containing these solid particles, to be separated into products with distinct characteristics and uses, for example products (i) enriched in relatively high density solids such as slag, (ii) enriched in relatively low density solids such as fly slag, and/or (iii) enriched in water-soluble compounds such as chloride- and nitrogen-containing compounds.

The term “floating/suspended solids” is meant to embrace low density solids such as fly slag (or fly ash) and other solids having a density substantially the same as or lower than that of water. The term “heavier solids” is meant to embrace high density solids such as slag and other solids having a density higher than that of water and higher than that of floating/suspended solids.

With respect to the use of separation stages to separate portions from a given starting material (e.g., in the case of separating a “dirty water portion” and a “suspended solids-containing portion” from an upper slag water portion as the starting material), the term “portion” is used herein to designate a separated material having a composition that differs from that of another separated material, or “portion,” and that also differs from that of the starting material. In the case of a “portion” withdrawn from an “upper” position of a vessel (i.e., from a relatively higher vertical position of the liquid level within this vessel), compared to a “portion” withdrawn from a “lower” position of the vessel (i.e., from a relatively lower vertical position of the liquid level within this vessel), the portion withdrawn from the upper position will generally contain solids with an overall lower density relative to solids contained in the portion withdrawn from the lower position, as well as relative to solids contained in the starting material. Conversely, the portion withdrawn from the lower position will generally contain solids with an overall higher density relative to solids contained in the portion withdrawn from the upper position, as well as relative to solids contained in the starting material. In some embodiments, a portion withdrawn from an “upper” position may refer to that withdrawn from a vessel overhead (i.e., withdrawn from the top of a given separation vessel), whereas a portion withdrawn from a “lower” position may refer more specifically to that withdrawn from a vessel bottoms (i.e., withdrawn from the bottom of a given separation vessel). Any “portion” should be understood to mean the net material being separated, or withdrawn from a separation vessel, not accounting for material being recirculated. Therefore, for example, in the case of the lower slag water portion 109 with reference to FIG. 1, this refers more particularly to the net material withdrawn from the lower portion of vessel 150, excluding any recirculation of lean slag water portion 124 (obtained via a second stage of separation) through first and/or second lean slag water recirculation valves 175, 180.

With respect to portions that are separated from a given starting material, reference to one portion being “enriched in” a type of solids (e.g., in the case of the upper slag water portion, separated from the slag-containing water and being enriched in floating/suspended solids), unless expressly indicated to the contrary, means that the indicated portion (e.g., upper slag water portion) has, relative to the other portion (e.g., lower slag water portion), a higher content (wt-%) of the indicated type of solids (e.g., floating/suspended solids), and/or a higher recovery (%) of the indicated type of solids (e.g., floating/suspended solids) from the starting material (e.g., slag-containing water). Reference to one portion being “enriched in” a type of solids (e.g., floating/suspended solids) may alternatively, or in combination, mean that the indicated portion (e.g., upper slag water portion) has a higher content of the indicated type of solids (e.g., floating/suspended solids), relative to the starting material (e.g., slag-containing water).

In the same manner, reference to one portion being “depleted in” a type of solids (e.g., in the case of the upper slag water portion, separated from the slag-containing water and being depleted in heavier solids), unless expressly indicated to the contrary, means that the indicated portion (e.g., upper slag water portion) has, relative to the other portion (e.g., lower slag water portion), a lower content (wt-%) of the indicated type of solids (e.g., heavier solids), and/or a lower recovery (%) of the indicated type of solids (e.g., heavier solids) from the starting material (e.g., slag-containing water). Reference to one portion being “depleted in” a type of solids (e.g., heavier solids) may alternatively, or in combination, mean that the indicated portion (e.g., upper slag water portion) has a lower content of the indicated type of solids (e.g., heavier solids), relative to the starting material (e.g., slag-containing water).

As opposed to the term “portion” that is used to designate separated material having a composition that differs from another “portion” as well as from the starting material from which the portions are separated, the term “part,” such as used in the phrases “at least a first part of the dirty water portion” or “at least part of the suspended solids-containing water portion,” is used herein to designate a separated material having the same, or substantially the same, composition as that from which it has been separated. A “part” of a separated material may therefore be considered a fraction of that material which is the same in all respects except for, normally, its quantity. A “part” of the dirty water portion therefore has the same, or substantially the same, composition as the dirty water portion, and a “part” of the suspended solids-containing water portion has the same, or substantially the same, composition as the suspended solids-containing water portion. However, it can also be appreciated that a “solids-containing water product,” despite containing “at least part of the suspended solids-containing water portion,” will generally have a composition that differs from the suspended solids-containing water portion.

Representative processes described herein for the gasification of a carbonaceous feed, and which may be advantageously integrated with recovering products from solids-containing water as also described herein, may comprise a number of unit operations, with one of such operations stated as being performed or carried out “before,” “prior to,” or “upstream of” another of such operations, or with one of such operations being performed or carried out “after,” “subsequent to,” or “downstream of,” another of such operations. These quoted phrases, which refer to the order in which one operation is performed or carried out relative to another, are in reference to the overall process flow, as would be appreciated by one skilled in the art having knowledge of the present specification. More specifically, the overall process flow can be defined by the bulk gasifier effluent flow, as such flow is subjected to operations as defined herein. Insofar as the quoted phrases are used to designate order, in specific embodiments these phrases mean that one operation immediately precedes or follows another operation, whereas more generally these phrases do not preclude the possibility of intervening operations. Therefore, for example, one or more “operations downstream of the gasifier” can refer, according to a specific embodiment, an operation that immediately follows the gasifier, such as in the case of a tar removal operation according to the embodiment illustrated in FIG. 2. However, this phrase more generally, and preferably, refers to any of, or any combination of, operations that follow the gasifier, whether or not intervening operations are present, such as in the case of any one or more of a quenching operation, a radiant syngas cooler (RSC) or convective syngas cooler (CSC), and/or a filtration operation that follow the tar removal operation, as an intervening operation, according to the embodiment illustrated in FIG. 2. Therefore, to the extent that representative processes described herein are defined as including certain unit operations, unless otherwise stated or designated (e.g., by using the phrase “consisting of”), such processes do not preclude the use of other operations, whether or not specifically described herein.

Specific processes described herein are defined by a gasifier, a scrubbing operation (e.g., wet scrubber) downstream of the gasifier, and a WGS operation downstream of the scrubbing operation. The gasifier provides a “gasifier effluent” and the WGS operation provides a “WGS product.” The term “gasifier effluent” is a general term that refers to the effluent of the gasifier, whether or not having been subjected to one or more operations downstream of the gasifier and upstream of the WGS operation. The “gasifier effluent” may be more particularly designated as an “un-scrubbed gasifier effluent” or a “scrubbed gasifier effluent,” which are also general terms but add specificity in terms of characterizing the gasifier effluent depending on whether or not it has been subjected to the scrubbing operation.

The terms “gasifier effluent” and “un-scrubbed gasifier effluent” encompass more specific terms that designate (i) the effluent provided directly by the gasifier, i.e., the “raw gasifier effluent,” (ii) the raw gasifier effluent having been subjected to at least a tar removal operation, i.e., a “tar-depleted gasifier effluent,” having a lower concentration of tars and oils relative to the raw gasifier effluent, (iii) the raw gasifier effluent having been subjected to at least a dry quenching operation, i.e., a “quenched gasifier effluent,” having a lower temperature and higher moisture (H₂O) concentration relative to the raw gasifier effluent, resulting from direct quenching (e.g., partial quenching) with water, (iv) the raw gasifier effluent having been subjected to at least a radiant syngas cooler (RSC) or at least a convective syngas cooler (CSC), i.e., a “cooled gasifier effluent” having a lower temperature relative to the raw gasifier effluent, resulting from heat transfer for external steam generation, (v) the raw gasifier effluent having been subjected to at least a filtration operation, i.e., a “filtered gasifier effluent,” having a lower solid particle content relative to the raw gasifier effluent, and which may provide all or part of a “heated scrubber feed,” (vi) the raw gasifier effluent having been subjected to removal of heat, and which may provide all or part of a “scrubber feed,” having a lower temperature relative to the raw gasifier effluent, resulting from heat removal (e.g., to generate steam), and (vii) the raw gasifier effluent having been subjected to any other operation upstream of the scrubbing operation, whether or not specifically described herein.

Likewise, the terms “gasifier effluent” and “scrubbed gasifier effluent” encompass more specific terms that designate (viii) the raw gasifier effluent or un-scrubbed gasifier effluent having been subjected to a scrubbing operation to reduce its content of water-soluble contaminants (e.g., chloride-containing compounds and nitrogen-containing compounds), and (ix) the raw gasifier effluent or scrubbed gasifier effluent having been subjected to any other operation downstream of the scrubbing operation, whether or not specifically described herein. The terms “gasifier effluent,” “un-scrubbed gasifier effluent,” and “scrubbed gasifier effluent,” and any of the more specific examples (i)-(ix) of these terms, encompass products (e.g., flow streams) that are upstream of, and optionally may be fed to, the WGS operation.

The term “WGS product” is a general term that refers to a product of the WGS operation, all or a portion of which may, according to particular embodiments, be fed to a syngas conversion operation or a syngas separation operation to provide as a value-added product, a renewable syngas conversion product or a renewable syngas separation product. The term “WGS product” encompasses all or a portion of the product provided directly by the WGS operation, or otherwise such product after having been subjected to heating, cooling, pressurization, depressurization, and/or purification, such as acid gas removal.

The term “syngas,” or alternatively “synthesis gas product,” insofar as they relate to streams comprising H₂ and CO, are used herein to generally refer to the gasifier effluent, whether an un-scrubbed gasifier effluent or a scrubbed gasifier effluent as defined above, or the WGS product. The term “water,” such as used in the phrase “solids-containing water,” or, more specifically, “slag-containing water,” as well as in other phrases, is meant to encompass aqueous solutions having dissolved therein any water-soluble compounds including those specifically mentioned herein (e.g., chloride- and/or nitrogen-containing compounds). Therefore, phrases such as “solids-containing water” and “slag-containing water” should be understood to mean “solids-containing aqueous solution” and “slag-containing aqueous solution.”

Particular examples of renewable syngas conversion products and renewable syngas separation products include both renewable liquid products (e.g., liquid hydrocarbons or methanol) and renewable gaseous products (e.g., renewable natural gas (RNG) or renewable hydrogen). The modifiers “syngas conversion” and “syngas separation,” as well as the modifiers “conversion” and “separation,” as used in the terms “renewable syngas conversion product,” “renewable syngas separation product,” “gaseous conversion byproduct,” “liquid conversion byproduct,” and “gaseous separation byproduct” are meant to more specifically designate the origin of these products and byproducts, as being obtained from either a syngas conversion operation (e.g., comprising a Fischer-Tropsch reaction stage, a methanol synthesis reaction stage, or a methanation reaction stage) or a syngas separation operation (e.g., comprising a hydrogen purification stage, such as in the case of syngas separation by pressure swing adsorption (PSA) and/or the use of a membrane). Any such syngas conversion operation or syngas separation operation is preferably performed on the WGS product that can yield an increased, and more favorable, H₂:CO molar ratio, in terms of efficiently performing the desired conversion or separation. The use of the modifiers “separation” and “conversion” in the terms noted above to modify products and byproducts does not preclude such products and byproducts being obtained from a combination of separation and conversion.

### FURTHER EXEMPLARY EMBODIMENTS OF GASIFICATION PROCESSES

FIG. 1 depicts a flowscheme illustrating an embodiment of a process for the separation and recovery of products from solids-containing (e.g., slag-containing) water 100. Representative processes comprise withdrawing, from respective upper and lower positions of vessel 150, upper slag water portion 108 and lower slag water portion 109 of solids-containing water 100. These upper and lower positions may correspond to respective vertical (e.g., axial) heights of the liquid level within vessel 150, which may be considered a first stage separation vessel. Lower slag water portion 109 refers, more particularly, to the net material withdrawn from the lower portion of vessel, excluding any recirculation of lean slag water portion 124 (obtained via a second stage of separation) through first and/or second lean slag water recirculation valves 175, 180. With respect to the terms “enriched in” and “depleted in” as defined above, upper slag water portion 108 may be enriched in floating/suspended solids and/or depleted in heavier solids, whereas lower slag water portion 109 may be enriched in heaver solids and/or depleted in floating/suspended solids. For example, upper slag water portion 108 may be enriched in floating/suspended solids (or solids having a density substantially the same as or lower than that of water), in terms of having a higher content of such solids and/or a higher recovery of such solids from slag-containing water 100, relative to the net material withdrawn from a lower position, such as a bottoms, of vessel 150. Relative to upper slag water portion 108, this net material, withdrawn as lower slag water portion 109, may have a higher overall solids content.

In some embodiments, vessel 150 of FIG. 1 may be, or may correspond to, radiant syngas cooler (RSC) 65 or convective syngas cooler (CSC) 65, as shown in FIG. 2, or otherwise a component, such as a slag water sump or reservoir, of RSC or CSC 65 as shown in FIG. 2. In other embodiments, vessel 150 of FIG. 1 may be, or may correspond to, quenching operation 60 as shown in FIG. 2, or otherwise a component, such as a slag water sump or reservoir, of quenching operation 60 as shown in FIG. 2. Insofar as vessel 150 may generally be used in an apparatus for cooling gasifier effluent 102, such vessel may comprise heat exchanger tubes to aid in heat recovery from this stream. A suitable medium, such as boiler feed water, flowing in these tubes can be utilized for indirect heat transfer, for example by generating steam (e.g., high pressure steam) that may be used internally within the process, for heating needs, or exported. In one embodiment, the tubes may be connected in a ring configuration, with gasifier effluent 102, as a hot syngas stream, flowing through the center of this ring (e.g., waterwall). At typical gasifier effluent temperatures, heat is transferred primary by radiation.

In the case of vessel 150 being used for cooling or for another purpose, solids-containing (e.g., slag-containing) water 100 may be obtained from contacting, within vessel 150, gasifier effluent 102 (or more generally a solids-containing gaseous effluent from any industrial process, such as a Pox process or an ATR process), with makeup water 106. This makeup water may be any suitable source of process water, and may preferably be substantially free of solids, such as in the case of boiler feed water (BFW) that is typically available as a utility in processing facilities. For example, BFW or other makeup water source may be used in forming a sump or pool of water at the bottom of a syngas cooler, such as an RSC, CSC, or cooler used in a quenching operation. A flowing gasifier effluent 102, as a hot syngas stream, may contact this pool of water, such as by passing over its surface before exiting vessel, for example as cooled or quenched gasifier effluent 104. This contacting is performed such that solids, for example slag and fly slag, present in gasifier effluent 102 (or other solids-containing gaseous effluent) are collected in solids-containing water 100 and thereby removed from the gas stream. According to particular embodiments, gasifier effluent 102 of FIG. 1 may correspond to any of raw gasifier effluent 16, tar-depleted gasifier effluent 18, or quenched gasifier effluent 22, according to the embodiment illustrated in FIG. 2. That is, gasifier effluent 102, may be obtained directly from gasifier 50 (FIG. 2) as a raw gasifier effluent, may be obtained directly from tar removal operation 55 (FIG. 2) as a tar-depleted gasifier effluent, or may be obtained directly from quenching operation 60 (FIG. 2) as a quenched gasifier effluent. According to particular embodiments, cooled or quenched gasifier effluent 104 of FIG. 1 may correspond to quenched gasifier effluent 22 or cooled gasifier effluent 24, according to the embodiment illustrated in FIG. 2. That is, cooled or quenched gasifier effluent 104 may be obtained directly from quenching operation 60 (FIG. 2) as a quenched gasifier effluent, or may be obtained directly from RSC or CSC 65 (FIG. 2) as a cooled gasifier effluent.

Following a first stage of separation in vessel 150, one or both of the obtained, upper slag water portion 108 and lower slag water portion 109 may be further separated in a second stage of separation. For example, representative processes may comprise separating upper slag water portion 108 into dirty water portion 110 and suspended solids-containing water portion 116, withdrawn from respective upper and lower positions of second stage upper separation vessel 155. These upper and lower positions may correspond to respective vertical (e.g., axial) heights of the liquid level within this vessel. Alternatively, or in combination, representative processes may comprise separating lower slag water portion 109 into lean slag water portion 124 and rich slag water portion 118, withdrawn from respective upper and lower positions of second stage lower separation vessel 160. These upper and lower positions may correspond to respective vertical (e.g., axial) heights of the liquid level within this vessel. With respect to the terms “enriched in” and “depleted in” as defined above, dirty water portion 108 may be depleted in floating/suspended solids and/or solids-containing water portion 116 may be enriched in floating/suspended solids. Also, lean slag water portion 124 may be enriched in floating/suspended solids and/or depleted in heavier solids, whereas rich slag water portion 118 may be depleted in floating/suspended solids and/or enriched in heavier solids.

Products may be recovered, following the first stage of separation from vessel 150 and the second stage(s) of separation from one or both of second stage upper separation vessel 155 and second stage lower separation vessel 160. For example, representative processes may comprise recovering all or part (e.g., at least a first part) of dirty water portion 110 as dirty water product 112. Alternatively, or in combination, representative processes may comprise recovering at least part of suspended solids-containing water portion 116 and/or at least part of rich slag water portion 118, in a solids-containing water product. With reference to FIG. 1, the solids-containing water product may be, for example, lean solids-containing water product 120 or rich solids-containing water product 122. Otherwise, these solids-containing water products 120, 122 may be considered as separated portions from a starting material comprising (i) all or part of suspended solids-containing water portion 116, (ii) all or part of rich slag water portion 118, or (iii) a combination of (i) and (ii). For example, all of suspended solids-containing water portion 116 and/or all of rich slag water portion 118 may be separated into lean solids-containing water product 120 and rich solids-containing water product 122. According to some embodiments, representative processes may comprise combining at least part of suspended solids-containing water portion 116 and at least part of rich slag water portion 118 to provide a combined, second stage water product, as the solids-containing water product. Such processes may further comprise separating this combined, second stage water product into lean solids-containing water product 120 and rich solids-containing water product 122.

Regardless of which portion(s) or part(s) of these portion(s) are separated, this separation may be carried out utilizing lean/rich separation vessel 165. For example, lean solids-containing water product 120 and rich solids-containing water product 122 may be withdrawn from respective upper and lower positions of this vessel, corresponding to respective vertical (e.g., axial) heights of the liquid level within lean/rich separation vessel 165. With respect to the terms “enriched in” and “depleted in” as defined above, and according to any embodiment described herein, rich solids-containing water product 122 may be enriched in heavier solids and/or floating/suspended solids, whereas lean solids-containing water product 120 may be depleted in heavier solids and/or floating suspended solids.

Overall, however, the use of two separate vessels, such as second stage upper separation vessel 155 and second stage lower separation vessel 160, for separation of solids-containing water 100 (e.g., obtained from the sump of an RSC or CSC) advantageously allows for the use of separate methods to concentrate (or further concentrate) solids, with specific methods being selected for specific applications. Representative methods in this regard include velocity concentration through the use of a hydrocyclone, as well as gravity settling. For example, according to specific embodiments, the former method may be used to concentrate “light solids” obtained from second stage upper separation vessel 155 (e.g., to concentrate solids in suspended solids-containing water portion 116) and/or the latter method may be used to concentrate “heavy solids” obtained from second stage lower separation vessel 160 (e.g., to concentrate solids in rich slag water portion 118).

Separation of slag-containing water 100 or other solids-containing water into various products may be accompanied by the return and/or recirculation of parts of process streams described herein, as needed to attain desired resolution of solid types in, desired compositions of, and/or amounts of, these products. For example, processes may further comprise adding second part 114 of dirty water portion 110 to second stage lower separation vessel 160. This addition may be performed continuously or intermittently (e.g., in response to a change in the composition of slag-containing water 100, a change in the carbonaceous feed being processed, or a change in operating conditions used to transform the carbonaceous feed into syngas), such as via dirty water return valve 170. Alternatively, or in combination, processes may further comprise adding (e.g., recirculating) (i) first part 126 of lean slag water portion 124 to lower slag water portion 109, and/or (ii) second part 128 of lean slag water portion 124 to slag-containing water 100, or to vessel 150. Optionally in combination with lean slag water recirculation pump 185, recirculating of (i) may be performed continuously or intermittently via first lean slag water recirculation valve 175, and/or recirculating of (ii) may be performed continuously or intermittently via second lean slag water recirculation valve 180. As in the case of returning second 114 of dirty water portion 110, intermittent recirculation of (i) and/or (ii) may be performed in response to a change in the composition of slag-containing water 100, a change in the carbonaceous feed being processed, or a change in operating conditions used to transform the carbonaceous feed into syngas. Intermittent operation may be performed to maintain a given target or setpoint composition of a product (e.g., content of solids, or type of solids, in any of the dirty water product, lean solids-containing water product, or rich solids-containing water product).

According to any of the embodiments described herein, processes may be used to separate various grades of solids-containing water product from an initial solids-containing water, such as a slag-containing water. Such grades may be delineated by their overall solids content, their solids content with respect to a particular solid type (e.g., content of floating/suspended solids or content of heavier solids), and/or their content of water-soluble compounds (e.g., chloride-containing compounds and/or nitrogen-containing compounds). Separated products described herein, including the dirty water product, the lean solids-containing water product, and the rich solids-containing water product, may therefore be characterized as having different grades or measurable characteristics that meet specifications for different end uses (e.g., water treatment). According to particular embodiments, for example, the dirty water product may have a lower (overall) solids content relative to the lean solids-containing water product, which in turn may have a lower (overall) solids content relative to the rich solids-containing water product. According to other particular embodiments, the dirty water product may have a solids content from about 0.1 wt-% to about 5 wt-% (e.g., from about 0.2 wt-% to about 2 wt-%, or from about 0.5 wt-% to about 1.5 wt-%); the lean solids-containing water product may have a solids content from about 0.5 wt-% to about 10 wt-% (e.g., from about 1 wt-% to about 5 wt-%, or from about 1 wt-% to about 3 wt-%); and/or the rich solids-containing water product may have a solids content from about 25 wt-% to about 90 wt-% (e.g., from about 50 wt-% to about 85 wt-%, or from about 65 wt-% to about 80 wt-%).

FIG. 2 depicts a flowscheme illustrating an embodiment of a process for gasification of a carbonaceous feed, which includes operations that may generate solids-containing water (e.g., slag-containing water), allowing for integration with the recovery of products from such solids-containing water, as described herein. With reference to FIG. 2, and with the understanding that embodiments disclosed herein do not necessarily require all of the illustrated features, such embodiments may be directed to a process for gasification of a carbonaceous feed (e.g., wood) generally. The process may comprise, in gasifier 50, contacting carbonaceous feed 10 (or a dried carbonaceous feed, following drying) with oxygen-containing gasifier feed 14 (and optionally a separate source of steam) under gasification conditions to provide a gasifier effluent comprising H₂, CO, and solids comprising slag and fly ash. Oxygen-containing gasifier feed 14 alone (or possibly in combination with a separate source of steam), may comprise H₂O and O₂, as well as optionally CO₂, in a combined concentration of at least about 90 mol-%, at least about 95 mol-%, or at least about 99 mol-%.

The gasifier effluent may be any process stream downstream of gasifier 50 and upstream of RSC or CSC 65, including raw gasifier effluent 16, tar-depleted gasifier effluent 18, or quenched gasifier effluent 22. The process may further comprise, in a vessel of a cooling operation or a quenching operation, contacting at least a portion of this gasifier effluent, optionally following one or more intervening operations, with makeup water 106 (FIG. 1) to obtain (i) slag-containing water 100 (FIG. 1), and cooled or quenched gasifier effluent 104 (FIG. 1). The slag-containing water may be separated, such as by utilizing processes described herein, to recover at a least dirty water product and a solids-containing water product having respective, lower and higher solids contents, or otherwise compositions that differ in one or more respects. For example, with reference to FIG. 1, slag-containing water 100 may be separated to recover dirty water product 112, and both lean solids-containing water product 120 and rich solids-containing water product 122, all of which may have different solids contents or may have compositions that differ in one or more respects. According to particular embodiments, lean solids-containing water product 120 and rich solids-containing water product 122 may be separated from a combined, second stage water product, provided from combining portions of slag-containing water 100 that are obtained from separation by at least separation stages (e.g., in vessel 150, as a first stage separation vessel, and in either or both of second stage upper separation vessel 155 and second stage lower separation vessel 160, as second stage separation vessels).

In representative embodiments, and with reference to FIG. 2, the one or more intervening operations may include tar removal operation 55 to remove at least a portion of gasifier effluent tar, namely from raw gasifier effluent 16. In this case, the gasifier effluent, which is contacted in the cooling operation with makeup water, is namely tar-depleted gasifier effluent 18. Also, in representative embodiments, the cooling operation may comprise RSC 65 implementing heat-exchanging contact with RSC feed water or CSC 65 implementing heat-exchanging contact with CSC feed water. Otherwise, quenching operation 60 may comprise a quenching vessel implementing direct contact with quench water.

According to the particular embodiment illustrated in FIG. 2, raw gasifier effluent 16 produced in gasifier 50 is fed to tar removal operation 55, to provide tar-depleted gasifier effluent 18, having a lower amount of tar relative to raw gasifier effluent 16. A synthesis gas product may be recovered from tar-depleted gasifier effluent 16, with such synthesis gas product possibly including any process stream downstream of tar-depleted gasifier effluent 16 as illustrated in FIG. 2. For example, the synthesis gas product may be recovered as water-gas shift (WGS) product 36 of WGS operation 90, optionally following one or more intervening operations performed on the gasifier effluent, downstream of the tar removal operation and upstream of the WGS operation. Such intervening operations can include one or more of (i) quenching operation 60 comprising direct contact of the gasifier effluent with quench water 20, (ii) radiant syngas cooler (RSC) or convective syngas cooler (CSC) 65, implementing heat-exchanging contact of the gasifier effluent with RSC feed water or CSC feed water, (iii) filtration operation 70 to remove solid particles from the gasifier effluent, (iv) scrubber feed cooler 75 to remove heat from the filtered gasifier effluent 26 and control the temperature of downstream operations, and (v) scrubbing operation 80 to remove water-soluble contaminants from scrubber feed 28.

As more particularly illustrated in FIG. 2, a representative process comprises, in quenching operation 60, which may be more particularly a partial dry quench (PDQ) operation, contacting (e.g., by direct contact), tar-depleted gasifier effluent 18 with quench water 20. This provides quenched gasifier effluent 22, having a temperature that is decreased relative to that of tar-depleted gasifier effluent 18. The process may additionally comprise, in radiant syngas cooler (RSC) 65 or convective syngas cooler (CSC) 65, further cooling quenched gasifier effluent 22, such as by indirect, heat-exchanging contact with RSC feed water or CSC feed water. This provides cooled gasifier effluent 24, which may then be subjected to filtration operation 70, heat removal in scrubber feed cooler 75, and scrubbing operation 80, with particular details of these operations as described herein. In the case of scrubber feed cooler 75, boiler feed water 32 may be input for indirect heat exchange to provide generated steam 34 and scrubber feed, having a cooler temperature relative to filtered gasifier effluent 26 that is more suitable for scrubbing operation 80. Feeding at least a portion of scrubbed gasifier effluent 30, provided from scrubbing operation 80, to WGS operation 90, provides WGS product 36 having a H₂:CO molar ratio that is increased relative to that of raw gasifier effluent 16, and/or syngas exiting any of intervening operations, such as tar-depleted gasifier effluent 18, quenched gasifier effluent 22, cooled gasifier effluent 24, filtered gasifier effluent 26 exiting filtration operation 70, scrubber feed 28 to scrubbing operation 80, or scrubbed gasifier effluent 30 exiting scrubbing operation 80.

Representative processes may further comprise feeding at least a portion of WGS product 36 to syngas conversion operation 95 or syngas separation operation 95 to provide respective renewable syngas conversion product 40 or renewable syngas separation product 40. According to more specific embodiments, for example, (i) syngas conversion operation 95 may comprise a Fischer-Tropsch reaction stage, such that renewable syngas conversion product 40 comprises liquid hydrocarbons and/or oxygenates (e.g., alcohols) of varying carbon numbers, (ii) syngas conversion operation 95 may comprise a catalytic methanol synthesis reaction stage, such that renewable syngas conversion product 40 comprises methanol, or (iii) syngas conversion operation 95 may comprise a catalytic methanation reaction stage, such that renewable syngas conversion product 40 comprises RNG. According to other more specific embodiments, syngas separation operation 95 may comprise a renewable hydrogen separation stage, such that renewable syngas separation product 40 comprises purified hydrogen.

Representative gasification processes described herein are defined by various possible operations, occurring downstream of the gasifier which may include a tar removal operation; operations for cooling, such as a quenching operation, an RSC and/or a CSC; a filtration operation; scrubber feed cooling, such as by using a boiler; a scrubbing operation; a WGS operation; and a syngas conversion operation. Certain possible features of the gasifier, as well as these downstream operations and their associated process streams and conditions, according to preferred embodiments and otherwise any embodiments as defined in the claims, as well as the embodiments illustrated in the figures, are provided in the following description.

### Gasifier

Representative processes comprise, in a gasifier, contacting a carbonaceous feed with an oxygen-containing gasifier feed, under gasification conditions, to provide a gasifier effluent (e.g., a raw gasifier effluent) comprising synthesis gas.

The carbonaceous feed may comprise coal (e.g., high quality anthracite or bituminous coal, or lesser quality subbituminous, lignite, or peat), petroleum coke, asphaltene, and/or liquid petroleum residue, or other fossil-derived substance. In a preferred embodiment, the carbonaceous feed may comprise biomass. The term “biomass” refers to renewable (non-fossil-derived) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include vegetable oils, carbohydrates (e.g., sugars), organic waste materials, such as waste paper, construction, demolition wastes, digester sludge, and biosludge. Representative carbonaceous feeds therefore include, or comprise, any of these types of biomass. Particular carbonaceous feeds comprising biomass include municipal solid waste (MSW) or products derived from MSW, such as refuse derived fuel (RDF). Carbonaceous feeds may comprise a combination of fossil-derived and renewable substances, including those described above. A preferred carbonaceous feed is wood (e.g., in the form of wood chips).

In the gasifier (or, more particularly, a gasification reactor of this gasifier), the carbonaceous feed is subjected to partial oxidation in the presence of an oxygen-containing gasifier feed, added in an amount generally limited to supply only 20-70% of the oxygen that would be necessary for complete combustion. The oxygen-containing gasifier feed will generally comprise other oxygenated gaseous components including H₂O and/or CO₂ that may likewise serve as oxidants of the carbonaceous feed. The oxygen-containing gasifier feed can refer to all gases being fed or added to the gasifier, or otherwise can refer to gas that is separate from other gases being fed or added, whether subsequently combined upstream of, or within, the gasifier. For example, the oxygen-containing gasifier feed may be introduced to the gasifier, along with steam, or a portion of steam, generated elsewhere in the process (e.g., CSC-generated steam) and used as a separate feed. Contacting of the carbonaceous feed with the oxygen-containing gasifier feed in the gasifier provides a gasifier effluent, and more particularly a raw gasifier effluent as the product directly exiting the gasifier. One or more reactors (e.g., in series or parallel) of the gasifier may operate under gasification conditions present in such reactor(s), with these conditions including a temperature of generally from about 500 °C (932 °F) to about 1000 °C (1832 °F), and typically from about 816 °C (1500 °F) to about 1038 °C (1900 °F). Other gasification conditions may include atmospheric pressure or elevated pressure, for example an absolute pressure generally from about 0.1 megapascals (MPa) (14.5 psi) to about 10 MPa (1450 psi), and typically from about 1 MPa (145 psi) to about 3 MPa (435 psi), or from about 0.5 MPa (72 psi) to about 2 MPa (290 psi).

Gasification reactor configurations include counter-current fixed bed (“up draft”), co-current fixed bed (“down draft”), and entrained flow plasma. Different solid catalysts, having differing activities for one or more desired functions in gasification, such as tar reduction, enhanced H₂ yield, and/or reduced CO₂ yield, may be used. Limestone may be added to a gasification reactor, for example, to promote tar reduction by cracking. Various catalytic materials may be used in a gasification reactor, including solid particles of dolomite, supported nickel, alkali metals, and alkali metal compounds such as alkali metal carbonates, bicarbonates, and hydroxides. Often, a gasifier is operated with a gasification reactor having a fluidized bed of particles of the carbonaceous feed (and optionally particles of solid catalyst), with the oxygen-containing gasifier feed, and optionally separate, fluidizing H₂O- and/or CO₂-containing feeds, being fed upwardly through the particle bed. Exemplary types of fluidized beds include bubbling fluidized beds and entrained fluidized beds.

In addition to gasifier effluent tar, the raw gasifier effluent comprises CO, CO₂, and methane (CH₄) that are derived from the carbon present in the carbonaceous feed, as well as H₂ and/or H₂O, and generally both, together with other components in minor concentrations, as described below. According to the embodiment illustrated in the FIG. 2, the raw gasifier effluent 16 may be obtained directly from gasifier 50, prior to further operations as described herein.

The raw gasifier effluent, or any gasifier effluent having been subjected to one or more operations as described herein, may comprise synthesis gas, i.e., may comprise both H₂ and CO, with these components being present in various amounts (concentrations), and preferably in a combined amount of greater than about 25 mol-% (e.g., from about 25 mol-% to about 95 mol-%), greater than about 50 mol-% (e.g., from about 50 mol-% to about 90 mol-%), or greater than about 65 mol-% (e.g., from about 65 mol-% to about 85 mol-%). With respect to any such combined amounts (concentrations), the H₂:CO molar ratio of the gasifier effluent may be suitable for use in downstream syngas conversion operations (reactions or separations), such as (i) the conversion to a renewable syngas conversion product comprising higher molecular weight hydrocarbons and/or alcohols of varying carbon numbers via Fischer-Tropsch conversion or (ii) the conversion to a renewable syngas conversion product comprising methanol via a catalytic methanol synthesis reaction, or (iii) the conversion to a renewable syngas conversion product comprising renewable natural gas (RNG) via catalytic methanation that increases the methane content in a resulting RNG stream, or (iv) the separation of a renewable syngas separation product comprising purified hydrogen. More typically, however, a WGS operation is needed to achieve a favorable H₂:CO molar ratio, and/or a favorable H₂ concentration, for these or other downstream syngas conversion and separation operations. For example, the WGS operation may include parameters (e.g., reactor temperatures and/or catalyst types) for obtaining the highest yield/concentration of hydrogen, through consumption of CO present in the syngas upstream of this operation, in the case obtaining purified hydrogen as a renewable syngas separation product (e.g., by utilizing one or more PSA and/or membrane separation stages).

Independently of, or in combination with, the representative amounts (concentrations) of H₂ and CO above, the gasifier effluent may comprise CO₂, for example in an amount of at least about 2 mol-% (e.g., from about 2 mol-% to about 30 mol-%), at least about 5 mol-% (e.g., from about 5 mol-% to about 25 mol-%), or at least about 10 mol-% (e.g., from about 10 mol-% to about 20 mol-%). Independently of, or in combination with, the representative amounts (concentrations) of H₂, CO, and CO₂ above, the gasifier effluent may comprise CH₄, for example in an amount of at least about 0.5 mol-% (e.g., from about 0.5 mol-% to about 15 mol-%), at least about 1 mol-% (e.g., from about 1 mol-% to about 10 mol-%), or at least about 2 mol-% (e.g., from about 2 mol-% to about 8 mol-%). Together with any water vapor (H₂O), these non-condensable gases H₂, CO, CO₂, and CH₄ may account for substantially all of the composition of the gasifier effluent. That is, these non-condensable gases and any water may be present in the gasifier effluent in a combined amount of at least about 90 mol-%, at least about 95 mol-%, or even at least about 99 mol-%.

### Tar Removal Operation

The raw gasifier effluent, obtained directly from the gasifier, will generally comprise gasifier effluent tar, such that a tar removal operation is typically necessary for further processing. This gasifier effluent tar can include compounds that are referred to in the art as “tars” and “oils” and are more particularly hydrocarbons and oxygenated hydrocarbons having molecular weights greater than that of methane, which may be present in the gasifier effluent at concentrations ranging from several wt-ppm to several wt-%. Certain types of these compounds, having relatively high molecular weight, are further characterized by being problematic due to their tendency to condense at lower temperatures and coat internal surfaces of processing equipment, downstream of the gasifier, causing undesirable fouling, corrosion, and/or plugging. These compounds also interfere with subsequent processing steps, or syngas conversion operations, for upgrading synthesis gas to higher value products, which perform optimally (e.g., from the standpoint of stability) with pure feed gases.

Particular compounds that are undesirable for these reasons include hydrocarbons and oxygenated hydrocarbons having six carbon atoms or more (C₆⁺ hydrocarbons and oxygenated hydrocarbons), with benzene, toluene, xylenes, naphthalene, pyrene, phenol, and cresols being specific examples. These compounds are typically present in the raw gasifier effluent in a total (combined) amount from 1-100 g/Nm³. The removal (e.g., by conversion) of these organic compounds is therefore generally necessary to avoid serious problems caused by their deposition over time. Other types of tars and oils, such as ethane, ethylene, and acetylene, will not condense from the gasifier effluent but will nonetheless “tie up” hydrogen and carbon, with the effect of reducing the overall yield of H₂ and CO as the desired components of synthesis gas.

Depending on the specific tar removal operation, tars and oils in the raw gasifier effluent can be converted, either catalytically or non-catalytically, by oxidation, cracking, and/or reforming to provide, in the tar-depleted gasifier effluent, additional H₂ and CO. The tar conversion reaction(s) can utilize available O₂ or oxygen sources (e.g., H₂O and/or CO₂) that are present in, and/or added to, the synthesis gas. In view of the gasifier effluent tar, together with methane, containing a significant portion of the energy of the raw gasifier effluent, the conversion of these compounds can increase the overall yield of synthesis gas substantially. The tar removal operation, which may therefore, according to certain embodiments, be more specifically a tar conversion operation, can effectively reduce the concentration of compounds present as tar in the raw gasifier effluent, having been produced in the gasifier. In general, tar removal, and more particularly tar conversion reactions, may be performed under higher temperatures compared to those used in the gasifier, such that the tar-depleted gasifier effluent, obtained directly from the tar removal operation, may have a temperature of greater than about 1000 °C (e.g., from about 1000 °C (1832 °F) to about 1500 °C (2732 °F), such as from about 1204 °C (2200 °F) to about 1427 °C (2600 °F)).

According to one embodiment, the tar removal operation may be used for the conversion (e.g., reforming) of tar and methane through non-catalytic partial oxidation (Pox) in a reactor used for this operation. The efficiency of this specific operation can be promoted using hot oxygen burner (HOB) technology, according to which an excess of oxygen is mixed with a small amount of fuel (e.g., natural gas, propane, or recycled synthesis gas). Combustion of this fuel within the reactor can result in a temperature increase to above 1100 °C (2012 °F), causing the combustion products and excess oxygen to accelerate to sonic velocity through a nozzle, thereby forming a turbulent jet that enhances mixing between the tar/methane containing synthesis gas and the reactive hot oxygen stream. An HOB-based system can effectively improve synthesis gas yields.

In the case of a tar removal operation that utilizes catalytic conversion of tar and methane, this operation may include a reactor containing a bed of catalyst comprising solid or supported Ni, solid or supported Fe, and/or dolomite, for example in the form of a secondary fluidized bed downstream of the gasifier. Other catalysts for tar conversion include olivine, limestone, zeolites, and even metal-containing char produced from the gasification. As in the case of non-catalytic processes that may be performed in a tar removal operation, catalytic tar conversion may likewise include the introduction of supplemental oxygen and/or steam reactants, into a reactor used for this operation.

According to other particular embodiments, the tar removal operation may utilize a suitable liquid or solid adsorbent, to selectively adsorb tars and oils from the raw gasifier effluent. For example, the tar removal operation may be performed with an oil washing system, whereby the raw gasifier effluent is passed through (contacted with) a liquid medium such as bio-oil liquor, to extract the tars and oils based on their preferential solubility. The liquid adsorbent may be combusted after it has become spent.

Regardless of the particular method by which the tar removal operation is performed, the raw gasifier effluent may comprise tars and oils (e.g., present as compounds described above) in an amount, or combined amount, from about 0.01 wt-% to about 5 wt-%, such as from about 0.1 wt-% to about 3 wt-% or from about 0.5 wt-% to about 2 wt-%, The tar removal operation may be effective to substantially or completely remove this gasifier effluent tar. For example, the tar-depleted gasifier effluent exiting, or obtained directly from, this operation, may comprise tars and oils in an amount, or combined amount, of less than about 0.5 wt-%, less than about 0.1 wt-%, or less than about 0.01 wt-%. Representative levels of removal of tars and oils (e.g., by conversion), measured across the tar removal operation, may be at least about 90%, at least about 95%, or even at least about 99%, resulting in a tar-depleted gasifier effluent that may be substantially or completely free of tar.

### Quenching Operation

Hot gasifier effluent, for example the tar-depleted gasifier effluent exiting the tar removal operation, can be cooled by various techniques that include radiant and/or convective heat exchange. In representative embodiments, at least one quenching operation, and preferably a dry quenching operation, is used, in which water is added directly to the gasifier effluent and contributes to its overall moisture content, thereby favoring H₂ production via the equilibrium-limited WGS reaction (i.e., to provide an increased H₂:CO molar ratio and an increased H₂ concentration). A dry quenching operation utilizes the sensible heat of the gasifier effluent to vaporize the injected water, which is sufficient for obtaining the resulting quenched gasifier effluent at a desired, cooler temperature. In the case of using dry quenching without the further use of an RSC, the quenched gasifier effluent may have a temperature from about 400 °C (752 °F) to about 900 °C (1652 °F), and preferably from about 538 °C (1000 °F) to about 816 °C (1500 °F) to allow for further processing. Representative processes can include, after sufficient further cooling (e.g., using a CSC) a subsequent filtration operation (passage through a filter) to remove solid particles (e.g., dust). In preferred embodiments, only a partial quench is used in the quenching operation, as opposed to a full quench, such that the quenched gasifier effluent exiting, or obtained directly from, the dry quenching operation is above its dewpoint, i.e., not saturated. In general, the dry quenching operation can promote rapid and efficient cooling through direct contact between hot gasifier effluent and water or other aqueous quenching medium. A sump or pool of water at the bottom of a quenching operation may be used to collect solids entrained in the incoming syngas, such that this sump or pool may correspond to a slag-containing water according to embodiments described herein.

### Radiant Syngas Cooler (RSC) or Convective Syngas Cooler (CSC)

As described herein, according to preferred embodiments, a combination of a quenching operation characterized by direct contact of a synthesis gas (e.g., the tar-depleted gasifier effluent exiting the tar removal operation) and a quenching medium such as water, together with a CSC, can provide effective cooling for further downstream operations. Alternatively, or in combination, an RSC may be utilized for effective removal of ash and formed slag. For example, an RSC or CSC may be used to cool a quenched gasifier effluent exiting the quenching operation to provide a cooled gasifier effluent, with the quenched gasifier effluent optionally having a temperature within a range as described above and/or the cooled gasifier effluent having temperature from about 250 °C (482 °F) to about 600 °C (1112 °F), and preferably from about 275 °C (527 °F) to about 450 °C (842 °F) to allow for subsequent filtration. In some embodiments, an RSC or a CSC may be used to achieve such temperatures of a cooled gasifier effluent, in the absence of a quenching operation. In any event, an RSC or a CSC may operate by indirect heat transfer, such as in the case of having a shell and tube configuration, typically with the generation steam from some of the heat recovered from the gasifier and tar removal operation. According to more particular embodiments, an RSC or a CSC may operate as a boiler (e.g., a fire tube boiler or water tube boiler) for the production of medium and/or high pressure steam. A sump or pool of water at the bottom of a such cooler may be used to collect solids entrained in the incoming syngas, such that this sump or pool may correspond to a slag-containing water according to embodiments described herein.

### Filtration Operation

A filtration operation, using any suitable filter, may be used to remove solid particles (particulates) from the gasifier effluent, for example the cooled gasifier effluent as described above, exiting an RSC or a CSC. In the case of biomass gasification, these solid particles can include char, tar, soot, and ash, any of which can generally contain alkali metals such as sodium. Corrosive and/or harmful species such as chlorides, arsenic, and/or mercury may also be contained in such solid particles. A high temperature filtration, for example using bundles of metal or ceramic filters, may generally be sufficient to reduce the content of solid particles in the gasifier effluent, such as to provide a filtered gasifier effluent exiting, or obtained directly from, the filtration operation and having less than 1 wt-ppm, and possibly less than 0.1 wt-ppm of solid particles. In representative embodiments, the filtered gasifier effluent may have a temperature in a range as described above with respect to the cooled gasifier effluent.

In some embodiments, a filtration operation may be performed upstream of (prior to) the tar removal operation to allow the latter to operate more effectively. The removal of solid particles of varying average particles sizes, using filtration or other techniques, may be performed at any of a number of possible stages within the overall process. For example, coarse solids removal by centrifugation may be performed directly downstream of the gasifier, and/or may even be performed in situ in the gasifier (e.g., using internal cyclones, for removal of solid particles, positioned in a headspace above a fluidized particle bed).

The filtration operation may be followed by, or integrated with, a supplemental cleaning operation to further purify the gasifier effluent, such as to further reduce its tar and overall hydrocarbon content, for example by contact with a solid “polishing” material such as a carbon bed. This can provide for more thorough removal of benzene, naphthalene, pyrene, toluene, phenols, and other condensable species that could otherwise be detrimental to downstream operations, such as by deposition onto equipment.

### Steam Generation

Steam may be generated from heat present in a gasifier effluent, such as the filtered gasifier effluent described above and exiting, or obtained directly from, the filtration operation. According to some embodiments, a boiler may be used (e.g., a kettle boiler or other equipment that utilizes convective heat exchange) to carry out indirect heat exchange. Cooling of the filtered gasifier effluent, such as to provide a scrubber feed at a lower temperature, may be accompanied by heating boiler feed water, thereby performing steam generation that may optionally be integrated within the overall process.

Immediately upstream of a scrubber feed cooler, such as a boiler used for steam generation, filtered gasifier effluent may have a temperature within the ranges given above with respect to this stream, for example a temperature corresponding to that of the cooled gasifier effluent, which may be from about 250 °C (482 °F) to about 600 °C (1112 °F), and preferably from about 275 °C (527 °F) to about 450 °C (842 °F). In representative embodiments, the scrubber feed, as a consequence of the steam generation, may be cooled from a temperature within a range as described above to a temperature from about 100 °C (212 °F) to about 225 °C (437 °F), and preferably from about 105 °C (221 °F) to about 185 °C (365 °F). Such temperature may correspond to the scrubber gas inlet temperature or scrubber operating temperature.

### Scrubbing Operation

A scrubbing operation may be used to remove water and water-soluble contaminants from an un-scrubbed gasifier effluent, such as the scrubber feed obtained from the filtration operation, following cooling of filtered gasifier effluent to generate steam. The temperature of this scrubber feed may be controlled through varying of the amount of heat removed by the scrubber feed cooler, and the scrubbing operation itself may provide further cooling. For example, the scrubber feed entering the scrubber, following cooling for steam generation, may have a temperature as also described above, which corresponds to the scrubber gas inlet temperature. The scrubbed gasifier effluent exiting the scrubber may have a temperature from about 35 °C (95 °F) to about 100 °C (212 °F), and preferably from about 38 °C (100 °F) to about 66 °C (150 °F).

The scrubbing operation, such as wet scrubbing, may be effective for removing, as water-soluble contaminants, chlorides (e.g., in the form of HCl), ammonia, and HCN, as well as fine solid particles (e.g., char and ash). For example, in the case of using a wet scrubber, an un-scrubbed gasifier effluent, such as the scrubber feed obtained following cooling, may be fed to a trayed column to perform co-current or counter-current contacting with water or an aqueous solution. Further cooling in this column, such as to a temperature below 100 °C (212 °F) can aid in droplet condensation for improving the contaminant removal effectiveness. The scrubbing operation can be used to provide a scrubbed gasifier effluent exiting, or obtained directly from, this operation and having a combined amount of chloride, ammonia, and solid particles of less than 1 wt-ppm, and possibly less than 0.1 wt-ppm. The scrubbing operation also generally serves to remove water, such that the moisture content of the scrubbed gasifier effluent is reduced, relative to that of the scrubber feed.

### WGS Operation

The water gas shift (WGS) operation reacts CO present in a gasifier effluent, for example the scrubbed gasifier effluent immediately exiting the scrubbing operation, with steam to increase H₂ concentration (as well as CO₂ concentration). In this manner, the scrubbed gasifier effluent may be characterized as a feed to the WGS operation (WGS feed). Following the tar removal operation, filtration operation, and scrubbing operation, the scrubbed gasifier effluent/feed to the WGS operation may have favorable properties for use in this operation, in terms of its being free or substantially free of water-soluble contaminants as described above, as well as tars and particulates.

According to some embodiments, the scrubbed gasifier effluent/feed to the WGS operation may be heated and/or supplemented with moisture (steam) to further improve its properties for kinetically and/or thermodynamically favoring the WGS reaction that desirably increases the H₂:CO molar ratio and/or H₂ concentration of the WGS product relative these characteristics of the WGS feed. For example, this feed may be heated to a temperature from about 225 °C (437 °F) to about 475 °C (887 °F), and preferably from about 260 °C (500 °F) to about 399 °C (750 °F), prior to its input to the WGS operation. The moisture content of this feed may be augmented utilizing a supplemental source steam, such as at least a portion of the generated steam provided from the steam generation (e.g., using a boiler) as described above. For example, at least a portion of steam (e.g., low or medium pressure steam) generated in the boiler may be fed or added to the WGS operation (e.g., to one or more reactors used in this operation), thereby improving overall heat balancing/integration. In the WGS operation, the use of steam in excess of the stoichiometric amount may be beneficial, particularly in adiabatic, fixed-bed reactors, for a number of purposes. These include driving the equilibrium toward hydrogen production, adding heat capacity to limit the exothermic temperature rise, and minimizing side reactions, such as methanation.

Reactors used in a WGS operation may contain a suitable catalyst, such as those comprising one or more of Co, Ni, Mo, and W on a solid support, particular examples of which are Co/Mo and Ni/Mo catalysts that exhibit sulfur tolerance. Other catalysts for use in this operation (i.e., contained within one or more WGS reactors) include those based on copper-containing and/or zinc-containing catalysts, such as Cu—Zn—Al; chromium-containing catalysts; iron oxides; zinc ferrite; magnetite; chromium oxides; and any combination thereof (e.g., Fe₂O₃—Cr₂O₃ catalysts).

In a typical WGS operation, two or more reactors with interstage cooling are used in view of the thermodynamic characteristics of the WGS reaction. For example, a high-temperature shift (HTS) reactor may operate with a temperature of the reactor inlet from about 310 °C (590 °F) to about 450 °C (842 °F), with more favorable reaction kinetics but a less favorable equilibrium conversion. The effluent from the HTS may then be cooled to a temperature suitable for the reactor inlet of a low-temperature shift (LTS) reactor, such as from about 200 °C (392 °F) to about 250 °C (482 °F), for providing less favorable reaction kinetics but a more favorable equilibrium conversion, such that the combined effect of the HTS and LTS reactors results in a high conversion to H₂ with a favorable residence time. In some cases, it may be desirable to use three or more reactors, or catalyst beds, to perform the WGS reaction, again with cooling between consecutive reactors or catalyst beds.

In this manner, the WGS operation may be used to provide an immediate WGS product exiting, or obtained directly from, this operation and having an increased H₂:CO molar ratio and increased H₂ concentration, relative to the feed to the WGS operation or the synthesis gas obtained from upstream operations (e.g., filtered gasifier effluent or cooled gasifier effluent). For example, the immediate WGS product may have an H₂:CO molar ratio from about 0.5 to about 3.5, from about 1.0 to about 3.0, or from about 1.5 to about 2.5 and/or a hydrogen concentration of at least about 35 mol-% (e.g., from about 35 mol-% to about 80 mol-%), at least about 40 mol-% (e.g., from about 40 mol-% to about 70 mol-%), or at least about 45 mol-% (e.g., from about 45 mol-% to about 65 mol-%). These characteristics of the immediate WGS product may be controlled by bypassing the WGS operation to a greater or lesser extent (e.g., diverting a smaller or larger portion of the feed to this operation, around this operation to provide a portion of the immediate WGS product). The WGS operation may be further beneficial in terms of converting carbonyl sulfide (COS) to H₂S which can be recycled and more easily removed elsewhere in the process, such as in an acid gas removal operation or possibly, at least to some extent, in the scrubbing operation.

### Syngas Conversion or Separation Operations

In some embodiments, processes described herein may also include a syngas conversion operation or syngas separation operation to produce a respective renewable syngas conversion product or renewable syngas separation product, such as liquid hydrocarbons, methanol, or RNG as examples of conversion products, and purified hydrogen as an example of a separation product. In the case of liquid hydrocarbon production, the syngas conversion operation may comprise a Fischer-Tropsch (FT) reaction stage. One or more reactors in this stage are used to process the synthesis gas mixture of hydrogen (H₂) and carbon monoxide (CO) by successive cleavage of C—O bonds and formation of C—C bonds with the incorporation of hydrogen. This mechanism provides for the formation of hydrocarbons, and particularly straight-chain alkanes, with a distribution of molecular weights that can be controlled to some extent by varying the FT reaction conditions and catalyst properties. Such properties include pore size and other characteristics of the support material. The choice of FT catalyst and its active metals (e.g., Fe or Ru) can impact FT product yields in other respects, such as in the production of oxygenates.

In the case of methanol production, the syngas conversion operation may comprise a methanol synthesis reaction stage. One or more reactors in this stage are used to form methanol according to the catalytic reaction:

CO+2H₂→CH₃OH (1)

Representative catalysts for the synthesis of methanol by this route are characterized by “CZA,” which is a reference to copper and zinc on alumina, or Cu/ZnO/Al₂O₃. Alternatively, or in combination, various other catalytic metals and their oxides may be used, including one or more of W, Zr, In, Pd, Ti, Co, Ga, Ni, Ce, Au, Mn, and their combinations.

In the case of methane production as a syngas conversion operation to provide a renewable natural gas (RNG) product, one or more methanation reactors (e.g., in series or parallel) may be used to react CO and/or CO₂ with hydrogen and thereby provide a hot methanation product having a significantly higher concentration of methane relative to that initially present (e.g., in the WGS product). Catalysts suitable for use in a methanation reactor include supported metals such as ruthenium and/or other noble metals, as well as molybdenum and tungsten. Generally, however, supported nickel catalysts are most cost effective. Often, a methanation reactor is operated using a fixed bed of the catalyst.

In the case of purified hydrogen production, the syngas separation operation may comprise a renewable hydrogen separation stage that can utilize, for example, (i) an adsorbent in the case of separation by PSA or (ii) a membrane. Combinations of such stages may be used in a given syngas separation operation. In any such operation, a gaseous separation byproduct is also provided that is generally enriched in the non-hydrogen components of syngas, such as CO, CO₂, and/or H₂O. This byproduct may be, for example, a PSA tail gas or otherwise a membrane permeate or retentate, depending on the particular membrane used and consequently whether the renewable hydrogen separation product is recovered as the membrane retentate or permeate. This hydrogen, obtained as a result of utilizing a syngas separation operation downstream of the WGS operation, may, in some embodiments, be characterized as high purity hydrogen (e.g., having a purity of at least about 99 mol-% or more, such as at least 99.9 mol-% or at least 99.99 mol-%).

### EXAMPLES

The following examples are set forth as representative of the present invention. These examples are not to be construed as limiting the scope of the invention as other equivalent embodiments will be apparent in view of the present disclosure and appended claims.

With reference to the configuration shown in FIG. 1, the separation of slag-containing water as typically generated in a gasification process, was modeled. The process streams according to their associated reference numbers are listed in the following table:

| | |
|---|---|
| 106 | makeup water |
| 108 | upper slag water portion |
| 109 | lower slag water portion, combined with |
| | recirculated part 128 of lean slag water |
| | portion 124 |
| 110 | dirty water portion |
| 112 | dirty water product |
| 114 | second part of dirty water product, returned |
| | to second stage lower separation vessel |
| 116 | suspended solids-containing water portion |
| 118 | rich slag water portion |
| 124 | lean slag water portion |
| 128 | recirculated part of lean slag water portion |
| 120 | lean solids-containing water product |
| 122 | rich solids-containing water product |

According to this model, the flow rate of the makeup water was assumed to be 22,000 pounds per hour (lb/hr), with 200 lb/hr being evaporated into the incoming/exiting syngas and 700 lb/hr of solids from this syngas being recovered in this water, rendering it a slag-containing water. In the modeled embodiment, the entire lean slag water portion 124 withdrawn from the second stage lower separation vessel was recirculated back to the vessel 150.

Process stream data from this modelling study was summarized as follows:

| | liquid flow, | solids flow, | solids, |
|---|---|---|---|
| Stream | lb/hr | lb/hr | wt-% |
| 106 | 22,000 | 0 | 0 |
| 108 | 20,691 | 490 | 2.3 |
| 109 | 26,089 | 263 | 1.0 |
| 110 | 18,622 | 123 | 0.7 |
| 112 | 17,691 | 116 | 0.7 |
| 114 | 931 | 6 | 0.7 |
| 116 | 2,069 | 368 | 15.1 |
| 118 | 2,020 | 216 | 9.7 |
| 124 | 25,000 | 53 | 0.2 |
| 128 | 25,000 | 53 | 0.2 |
| 120 | 3,885 | 88 | 2.2 |
| 122 | 204 | 496 | 70.8 |

From these results, it can be appreciated that the dirty water product 112, lean solids-containing water product 120, and rich solids-containing water product 122 can be separated effectively with vastly different solids contents. The solids types were also found to be different, with the vast amount of heavier solids (e.g., slag) recovered in the rich solids-containing water product 122 and a considerable amount of floating/suspended solids (e.g., fly slag) recovered in the lean solids-containing water product 120, with the dirty water product 112 being suitable for water treatment.

Overall, aspects of the invention relate to methods for recovering products of varying compositions, and for various intermediate or end uses, from solids-containing water, such as slag-containing water that may be generated from industrial processes. Representative processes transform solid carbonaceous feeds (e.g., biomass) into syngas, with gasification being a particular example. Those skilled in the art, having knowledge of the present disclosure, will recognize that various changes can be made to these processes in attaining these and other advantages, without departing from the scope of the present disclosure. As such, it should be understood that the features of the disclosure are susceptible to modifications and/or substitutions, and the specific embodiments illustrated and described herein are for illustrative purposes only, and not limiting of the invention as set forth in the appended claims.

1. A process for recovering products from slag-containing water within a vessel, the process comprising:
(a) withdrawing, from respective upper and lower positions of the vessel, an upper slag water portion and a lower slag water portion;
(b) separating the upper slag water portion into a dirty water portion and a suspended solids-containing water portion, withdrawn from respective upper and lower positions of a second stage upper separation vessel; and/or
separating the lower slag water portion into a lean slag water portion and a rich slag water portion, withdrawn from respective upper and lower positions of a second stage lower separation vessel;
(c) recovering at least a first part of the dirty water portion as a dirty water product; and
(d) recovering at least part of the suspended solids-containing water portion and/or at least part of the rich slag water portion in a solids-containing water product.

2. The process of claim 1, wherein the upper slag water portion is enriched in floating/suspended solids, relative to the slag-containing water.

3. The process of claim 1, wherein the solids-containing water product is a lean solids-containing water product or a rich solids-containing water product.

4. The process of claim 3, wherein all of the suspended solids-containing water portion and/or all of the rich slag water portion is/are separated into the lean solids-containing water product and the rich solids-containing water product.

5. The process of claim 1, wherein the dirty water product has a lower solids content relative to the lean solids-containing water product and the lean solids-containing water product has a lower solids content relative to the rich solids-containing water product.

6. The process of claim 1, wherein the dirty water product has a solids content from about 0.2 wt-% to about 2 wt-%, the lean solids-containing water product has a solids content from about 1 wt-% to about 5 wt-%, and the rich solids-containing water product has a solids content from about 50 wt-% to about 85 wt-%.

7. The process of claim 1, further comprising combining the suspended solids-containing water portion and the rich slag water portion to provide a combined, second stage water product.

8. The process of claim 7, further comprising separating the combined, second stage water product into a lean solids-containing water product and a rich solids-containing water product.

9. The process of claim 1, further comprising adding a second part of the dirty water portion to the second stage lower separation vessel.

10. The process of claim 1, further comprising adding (i) a first part of the lean slag water portion to the lower slag water portion, and/or (ii) a second part of the lean slag water portion to the slag-containing water.

11. The process of claim 1, wherein the slag-containing water is obtained from contacting, within the vessel, a gasifier effluent with makeup water.

12. The process of claim 11, wherein the gasifier effluent is a raw gasifier effluent obtained directly from a gasifier, a tar-depleted gasifier effluent obtained directly from a tar removal operation, or a quenched gasifier effluent obtained directly from a quenching operation.

13. The process of claim 1, wherein the vessel comprises heat exchanger tubes.

14. The process of claim 1, wherein the vessel is a radiant syngas cooler (RSC) or a component of an RSC.

15. A process for gasification of a carbonaceous feed, the process comprising:
in a gasifier, contacting the carbonaceous feed with an oxygen-containing gasifier feed, under gasification conditions, to provide a gasifier effluent comprising H₂, CO, and solids comprising slag and fly ash,
in a cooling operation or a quenching operation, contacting all or part of the gasifier effluent, optionally following one or more intervening operations, with makeup water to obtain (i) a slag-containing water and (ii) a cooled or quenched gasifier effluent, and
separating the slag-containing water to recover at least a dirty water product and a solids-containing water product having respective, lower and higher solids contents.

16. The process of claim 15, wherein the slag-containing water is separated to recover the dirty water product and both a lean solids-containing water product and a rich solids-containing water product.

17. The process of claim 16, wherein the lean solids-containing water product and the rich solids-containing water product are separated from a combined, second stage water product, provided from combining portions of the slag-containing water that are obtained from separation by at least two separation stages.

18. The process of claim 15, wherein the one or more intervening operations includes a tar removal operation to remove at least a portion of gasifier effluent tar.

19. The process of claim 15, wherein the cooling operation comprises a radiant syngas cooler (RSC) implementing heat-exchanging contact with RSC feed water or a convective syngas cooler (CSC) implementing heat-exchanging contact with CSC feed water, or wherein the quenching operation comprises a quenching vessel implementing direct contact with quench water.

20. The process of claim 1, wherein the slag-containing water has a solids content from about 0.5 wt-% to about 10 wt-%.
